(19) United States
(12) Patent Application Publication
(10) Pub. No.: US 2012/0324288 A1
(43) Pub. Date: Dec. 20, 2012

(54) COMPUTING DEVICE AND METHOD FOR TESTING REDUNDANT ARRAY OF INDEPENDENT DISKS DEVICE

(75) Inventor: Chin-Jui HSU, Tu-Cheng (TW)

(73) Assignee: HON HAI PRECISION INDUSTRY CO., LTD., Tu-Cheng (TW)

(21) Appl. No.: 13/457,428

(22) Filed: Apr. 26, 2012

(30) Foreign Application Priority Data
Jun. 17, 2011 (TW) 100121334

(51) Int. Cl. G06F 11/26

(52) U.S. Cl. 714/32; 714/E11.159

(57) ABSTRACT

A computing device and method tests a redundant array of independent disks (RAID) device. The computing device controls a power supply device to cut off power of the RAID device, and controls the power supply device to provide the power to the RAID device after a predetermined time. The computing device reads an original test file from the RAID device and determines if the read file is identical to the original test file stored in the computing device. The computing device displays a test result of the RAID device on a display device of the computing device.

### BACKGROUND

1. Technical Field

Embodiments of the present disclosure relate to test processing technology, and particularly to a computing device, a storage medium, and a method for testing redundant array of independent disks (RAID) device.

2. Description of Related Art

A redundant array of independent disks (RAID) device is a storage structure that combines multiple physical disks into a logical unit. After the RAID device is manufactured, it is important to test performance of the RAID device before it is shipped to a custom. However, testing the RAID device is done manually by writing data into the RAID device and reading data from the RAID device, and a tester determines if the written data is identical to the read data. This is tedious and time consuming, and thus there is room for improvement in the art.

### BRIEF DESCRIPTION OF THE DRAWINGS

FIG. 1 is a view diagram of one embodiment of a computing device including a RAID test system.

FIG. 2 is a block diagram of one embodiment of the computing device included in FIG. 1.

FIG. 3 is a flowchart of one embodiment of a RAID test method using the computing device of FIG. 1.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computing system-readable medium or other storage device. Some non-limiting examples of non-transitory computing system-readable media include CDs, DVDs, BLU-RAY, flash memory, and hard disk drives.

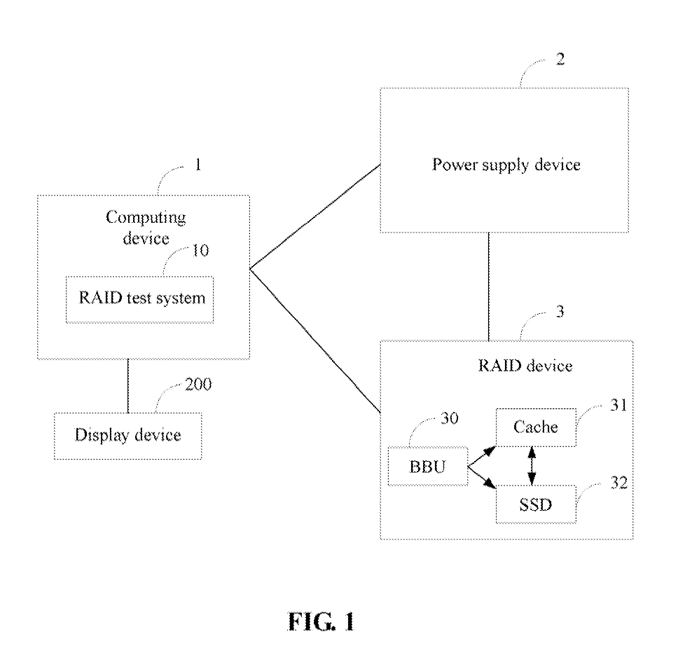

FIG. 1 is a view diagram of one embodiment of a computing device 1 including a redundant array of independent disks (RAID) test system 10. In one embodiment, the computing device 1 is electronically connected to a power supply device 2, a RAID device 3, and a display device 200. The power supply device 2 is also electronically connected to the RAID device 3, and provides power to the computing device 1 and the RAID device 3. The RAID test system 10 may be used to test stability of the RAID device 3.

The RAID device 3 includes a battery backup unit (BBU) 30, a cache 31, and a solid-state drive (SSD) 32. The BBU 30 temporarily provides the power to the cache 31 and the SSD 32 when the power provided by the power supply device 2 is cut off. Data stored in the cache 31 may disappear if the power of the cache 31 is cut off. The data stored in the SSD 32 does not disappear even if the power of the SSD 32 is cut off.

In one embodiment, the computing device 1 may be a computing device, a personal computer (PC), a network workstation computer, or any other data-processing equipment.

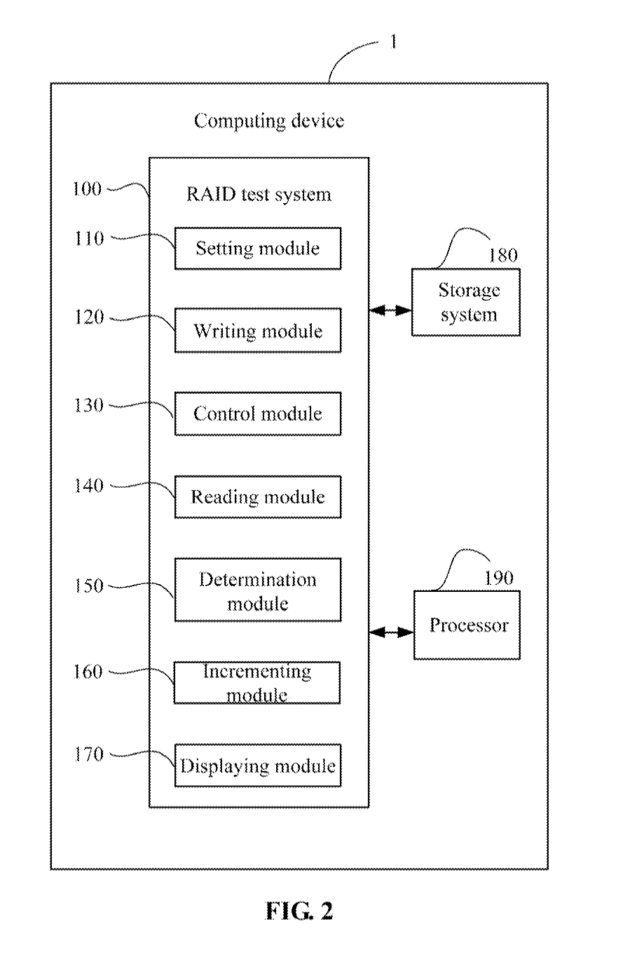

FIG. 2 is a block diagram of one embodiment of the computing device 1 included in FIG. 1. In the embodiment, the computing device 1 includes a storage system 180, at least one processor 190. In one embodiment, the RAID test system 100 further includes a setting module 110, a writing module 120, a control module 130, a reading module 140, a determination module 150, an incrementing module 160, and a displaying module 170. The modules 110-170 may include computerized code in the form of one or more programs that are stored in the storage system 180. The computerized code includes instructions that are executed by the at least one processor 190 to provide functions for modules 110-170. The storage system 180 may be an EPROM, a flash, or a hard drive.

In one embodiment, the storage system 180 further stores an original test file that includes one or more character strings, for example, a character string “hello, I am Lee.” The RAID test system 10 writes the character string into the RAID device 3 to test the stability of the RAID device 3.

The setting module 110 sets the original test file and a predetermined number (e.g., one hundred) to test the RAID device 3. In one embodiment, the original test file may be, but is not limited to, a TXT file, a portable document format (PDF) file, and a WORD file. A user may create the TXT file by inputting the character string “hello, I am Lee” and save the created TXT file into the storage system 180.

The writing module 120 writes the original test file into the RAID device 3. In one embodiment, the writing module 120 invokes a copy file command to write the TXT file into the cache 31 of the RAID device 3. The writing module 120 writes the original test file into the cache 31 of the RAID device 3 first, and the original test file is automatically transferred to the SSD 32 of the RAID device 3 after a specific time (e.g., one minute).

The control module 130 controls the power supply device 2 to cut off the power of the RAID device 3 for a predetermined time (e.g., two minutes). In one embodiment, the power supply device 2 receives a command and immediately stops providing the power to the RAID device 3 for more than one minute.

The control module 130 further controls the power supply device 2 to provide the power to the RAID device 3 after the predetermined time. In one embodiment, the power supply device 2 provides the power of the RAID device 3 after more than one minutes pass. For example, the power supply device 2 cuts off the power to the RAID device 3 for two minutes, and the power supply device 2 provides the power to the RAID device 3 after two minutes later.

The reading module 140 reads the original test file from the RAID device 3 when the power supply device 2 provides the power to the RAID device 3. In one embodiment, the reading module 140 reads the original test file from the SSD 32 of the RAID device 3.

The determination module 150 determines if the read file is identical to the original test file stored in the storage system 180. In one embodiment, assuming that the original test file is “hello, I am Lee,” if the read file is “hello, I am Lee,” and the read file is determined to be identical to the original test file. If the read file is “hello,” or some other words/characters, and the read file is determined to not be identical to the original test file.

The incrementing module 160 increments a test number of the RAID device 3 by one, in response to a determination that the read file is identical to the original test file. The incrementing module 160 may increment the test number by one after every time the incrementing module 160 is identical to the read file with the original test file. The test number is initially equal to zero.

The determination module 170 determines if the test number is equal to the predetermined number. For example, if the test number is one hundred and the predetermined number is one hundred, then the test number is equal to the predetermined number. Otherwise, if the test number is ninety and the predetermined number is one hundred, then the test number is unequal to the predetermined number.

The displaying module 180 displays a test result of the RAID device 3 on the display device 200 of the computing device 1. In one embodiment, the displaying module 180 displays the test qualified information on the display device 200, in response to a determination that the test number is equal to the predetermined number. For example, if the test number is one hundred, then the displaying module 260 displays “SUCCESS” on the display device 200. The displaying module 180 also displays the test unqualified information on the display device 200, in response to a determination that the read file is not identical to the original test file. For example, if the read file includes the character string, for example, “hello,” then the displaying module 180 displays “FAIL” on the display device 200.

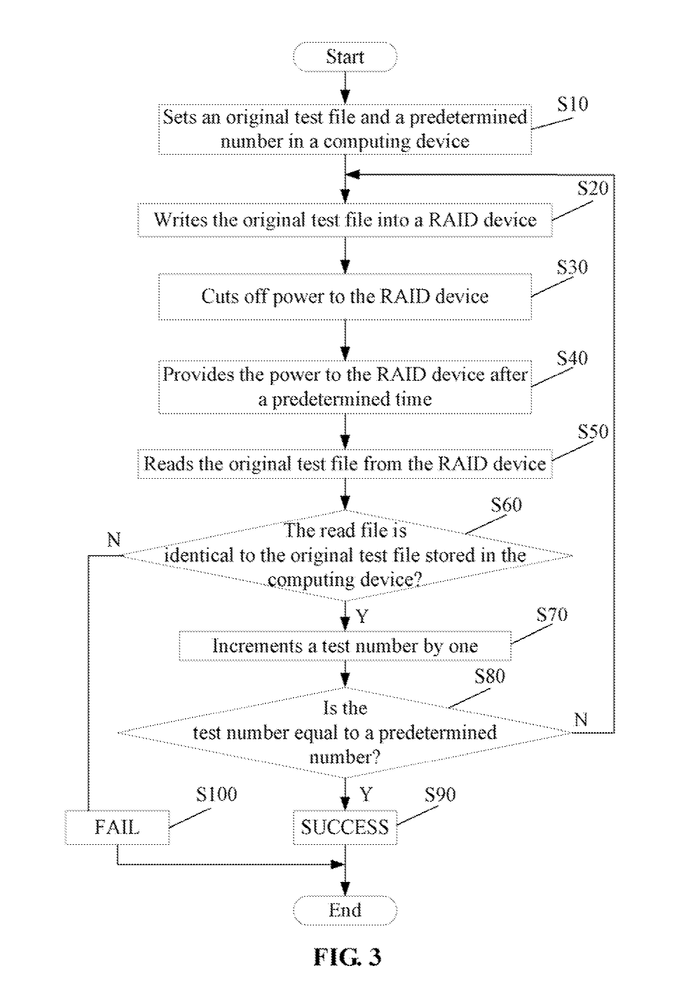

FIG. 3 is a flowchart of one embodiment of a RAID test method using the computing device 1 of FIG. 1. Depending on the embodiment, additional blocks may be added, others deleted, and the ordering of the blocks may be changed.

In step S10, the setting module 110 sets the original test file and a predetermined number (e.g., one hundred) to test the RAID device 3. As mentioned above, the original test file may be, but is not limited to, a TXT file, a portable document format (PDF) file, a WORD file. A user may create the TXT file by inputting some character string “hello, I am Lee” and save the TXT file into the storage system 180. In one embodiment, once an error occurs when the RAID device 3 is being tested, the test stops. In contrast, if the RAID device 3 is being tested without any error, the test does not stop until a frequency of the test is equal to the predetermined number (e.g., one hundred).

In step S20, the writing module 120 writes the original test file into the cache 31 of the RAID device 3. The writing module 120 writes the original test file into the cache 31 of the RAID device 3 first, and the original test file is automatically transferred to the SSD 32 of the RAID device 3 after a specific time (e.g., one minute).

In step S30, the control module 130 controls the power supply device 2 to cut off the power of the RAID device 3 for a predetermined time (e.g., two minutes). In one embodiment, the power supply device 2 receives a command and immediately stops providing the power to the RAID device 3 for more than one minute.

In step S40, the control module 130 further controls the power supply device 2 to provide the power to the RAID device 3 after the predetermined time.

In step S50, the reading module 140 reads the original test file from the SSD 32 of the RAID device 3 when the power supply device 2 provides the power to the RAID device 3.

In step S60, the determination module 150 determines if the read file is identical to the original test file stored in the storage system 180. In one embodiment, if the read file includes the character string “hello, I am Lee,” the read file is determined to be identical to the original test file, procedure goes to step S70. Otherwise, if the read file includes the character string “hello,” the read file is determined to not be identical to the original test file, procedure goes to step S100.

In step S70, the incrementing module 160 increments a test number of the RAID device 3. For example, the test number may be equal to one hundred.

In step S80, the determination module 170 determines if the test number is equal to the predetermined number. In one embodiment, if the test number is one hundred, the test number is equal to the predetermined number, procedure goes to step S90. Otherwise, if the test number is less than one hundred, the procedure returns to step S20.

In step S90, the displaying module 180 displays test qualified information on the display device 200 of the computing device 1 to indicate that the RAID device 3 is qualified. As mentioned above, the displaying module 180 displays “SUCCESS” on the display device 200 of the computing device 1 to indicate a satisfactory test.

In step S100, the displaying module 180 displays test unqualified information on the display device 200 of the computing device 1 to indicate that the RAID device 3 is unqualified. As mentioned above, the displaying module 180 displays “FAIL” on the display device 200 of the computing device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, the computing device in electronic communication with a redundant array of independent disks (RAID) device and a power supply device, the power supply device providing power to the computing device and the RAID device, the computing device comprising:
a storage system storing an original test file;
at least one processor; and
one or more programs stored in the storage system and being executable by the at least one processor, the one or more programs comprising:
a writing module that reads the original test file from the storage system, and writes the original test file into the RAID device;
a control module that controls the power supply device to cut off the power to the RAID device, and controls the power supply device to provide the power to the RAID device after a predetermined time;
a reading module that reads the original test file from the RAID device;
a determination module that determines if the read file is identical to the original test file;
an incrementing module that increments a test number of the RAID device by one until the test number is equal to a predetermined number, in response to a determination that the read file is identical to the original test file;
a display module that displays a test result of the RAID device on a display device of the computing device, in response to the determination that the test number is equal to the predetermined number.

2. The computing device of claim 1, wherein the RAID comprises a backup battery unit (BBU), a cache and a solid-state drive (SSD).

3. The computing device of claim 2, wherein the BBU temporarily provides the power to the cache and the SSD when the power supply device cuts off the power to the RAID device.

4. The computing device of claim 1, wherein the original test file is selected from the group consisting of a TXT file, a portable document format (PDF) file, and a WORD file.

5. The computing device of claim 1, wherein the display module displays the test result on the display device to indicate that the RAID device is unqualified, if the read file is not identical to the original test file.

6. The computing device of claim 1, wherein the display module displays the test result on the display device to indicate that the RAID device is qualified, if the test number is equal to the predetermined number.

7. A redundant array of independent disks (RAID) test method implemented by a computing device, the computing device in electronic communication with a RAID device and a power supply device, the power supply device providing power to the computing device and the RAID device, the method comprising:
reading an original test file from a storage system of the computing device, and writing the original test file into the RAID device;
controlling the power supply device to cut off the power to the RAID device, and controlling the power supply device to provide the power to the RAID device after a predetermined time;
reading the original test file from the RAID device when the power supply device provides the power to the RAID device;
incrementing a test number of the RAID device by one until the test number is equal to a predetermined number, in response to the determination that the read file is identical to the original test file; and
displaying a test result of the RAID device on a display device of the computing device, in response to a determination that the test number is equal to the predetermined number.

8. The method of claim 7, wherein the RAID device comprises a backup battery unit (BBU), a cache and a solid-state drive (SSD).

9. The method of claim 8, wherein the BBU temporarily provides the power to the cache and the SSD when the power supply device cuts off the power to the RAID device.

10. The method of claim 7, wherein the original test file is selected from the group consisting of a TXT file, a portable document format (PDF) file, and a WORD file.

11. The method of claim 7, wherein the test result is displayed on the display device to indicate that the RAID device is unqualified, if the read file is not identical to the original test file.

12. The method of claim 7, wherein the test result is displayed on the display device to indicate that the RAID device is qualified, if the test number is equal to the predetermined number.

13. A non-transitory computing system-readable medium having stored thereon instructions that, when executed by a computing device, the computing device in electronic communication with a redundant array of independent disks (RAID) device and a power supply device, the power supply device providing power to the computing device and the RAID device, the method comprising:
reading an original test file from a storage system of the computing device, and writing the original test file into the RAID device;
controlling the power supply device to cut off the power to the RAID device, and controlling the power supply device to provide the power to the RAID device after a predetermined time;
reading the original test file from the RAID device when the power supply device provides the power to the RAID device;
incrementing a test number of the RAID device by one until the test number is equal to a predetermined number, in response to the determination that the read file is identical to the original test file; and
displaying a test result of the RAID device on a display device of the computing device, in response to a determination that the test number is equal to the predetermined number.

14. The non-transitory medium of claim 13, wherein the RAID device comprises a backup battery unit (BBU), a cache and a solid-state drive (SSD).

15. The non-transitory medium of claim 14, wherein the BBU temporarily provides the power to the cache and the SSD when the power supply device cuts off the power to the RAID device.

16. The non-transitory method of claim 13, wherein the original test file is selected from the group consisting of a TXT file, a portable document format (PDF) file, and a WORD file.

17. The non-transitory method of claim 13, wherein the test result is displayed on the display device to indicate that the RAID device is unqualified, if the read file is not identical to the original test file.

18. The non-transitory method of claim 13, wherein the test result is displayed on the display device to indicate that the RAID device is qualified, if the test number is equal to the predetermined number.
